(19) United States
(12) Patent Application Publication
(10) Pub. No.: US 2026/0162324 A1
(43) Pub. Date: Jun. 11, 2026

(54) SEMANTICALLY-AWARE LAYOUTS FOR FAILURE MODE AND EFFECTS ANALYSES

(71) Applicant: SAP SE, Walldorf (DE)

(72) Inventor: Maximilian Kasselmann, Wiesloch (DE)

(73) Assignee: SAP SE, Walldorf (DE)

(21) Appl. No.: 18/974,735

(22) Filed: Dec. 9, 2024

(51) Int. Cl. G06T 11/20; G05B 23/02

(52) U.S. Cl. CPC G06T 11/26; G05B 23/0278

(57) ABSTRACT

A semantically-aware visual layout for a Failure Mode and Effects Analysis (FMEA) is generated based on semantic data for the FMEA and rendered for display via a user interface. A graph traversal is performed on the semantic data to create preliminary layout data, which is processed along with the semantic data to determine absolute positions for nodes and edges which take into account their semantic types and creation times. A visual representation of a layout for the FMEA is rendered based on the processed layout data, in which a focus FMEA group is centrally arranged, with superordinate and subordinate groups positioned to the left and right of the focus FMEA group at a downward offset. Within a given group, function nodes are centered below a system element node, and failure mode nodes are arranged in a cherry-on-tree formation below and to the right of a corresponding function node.

### FIELD

The field generally relates to computer-implemented techniques for generation of layouts for Failure Mode and Effects Analyses.

### BACKGROUND

Failure Mode and Effects Analysis (FMEA) is a risk analysis methodology used by manufacturing companies as part of product development. During development of a product, a system FMEA can be used to analyze the product and its components, whereas a process FMEA can be used to analyze the production process for the product. An FMEA can identify potential errors (referred to as failure modes) in various functions of a product or process, identify the causes and effects of the failure modes, and define measures for their detection and prevention.

Software tools for graph visualization can be used to generate graphical representations of FMEAs. However, as these tools use generic layout algorithms which do not take into account the internal semantics of FMEAs, they often fail to provide useful visual representations of FMEAs.

### BRIEF DESCRIPTION OF THE DRAWINGS

FIG. is a block diagram of an example system for generating semantically-aware graphical net layouts for visualization of FMEAs.

FIG. is a block diagram of an example semantically-aware functions net layout for visualization of FMEAs.

FIG. is a block diagram of an example semantically-aware full net layout for visualization of FMEAs.

FIG. is a flowchart of an example method of generating a semantically-aware graphical net layout for an FMEA.

FIG. is a block diagram of an example technique for determining the geometry of edges connecting failure mode nodes.

FIG. is a block diagram of an example layout pre-processing technique.

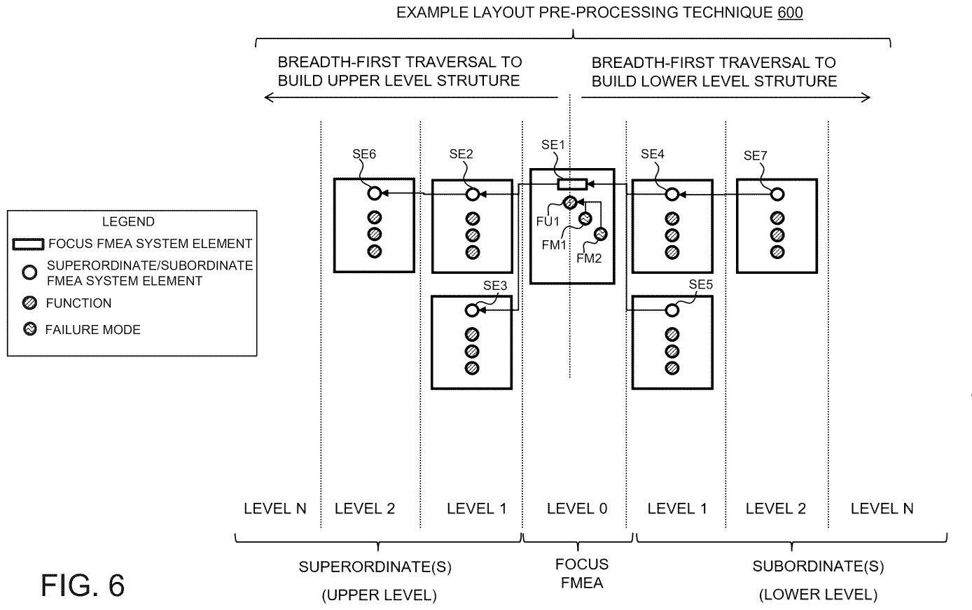

FIG. is a block diagram of an example output of the layout pre-processing technique shown in FIG. 6.

FIG. is a block diagram of an example semantically-aware graphical net layout in accordance with the technologies described herein.

FIG. is a block diagram of an example computing system in which described embodiments can be implemented.

FIG. is a block diagram of an example cloud computing environment that can be used in conjunction with the technologies described herein.

### DETAILED DESCRIPTION

### Example—Overview of Typical Visual Representations of FMEAs

In accordance with the FMEA methodology, an FMEA for a given process or system is typically associated with four visual representations: a structure net, a functions net, a failure net, and a full net. These visual representations are built on top of one another and are each associated with different levels of detail. According to the methodology, each visual representation is used in a different stage during risk analysis for the process or system.

A given FMEA includes a system element, which itself is sometimes referred to as an FMEA, Depending on the type of net visualized, (structure net, functions net, failure net, or full net), the given FMEA may also include other elements such as functions of the system element and failure modes of the functions. The system element along with any other elements of a given FMEA can be collectively referred to as an FMEA group (e.g., a focus FMEA group, a superordinate FMEA group, or a subordinate FMEA group).

The structure net of an FMEA differs depending on whether the FMEA is a process FMEA or a system FMEA. In a process FMEA, each process step in a production process is analyzed. Successor and predecessor steps of a process FMEA designated as a focus FMEA are modeled as superordinate and subordinate FMEAs, respectively. As used herein, superordinate and subordinate are relative terms defined from the perspective of the focus FMEA.

In a system FMEA, each component of the system (e.g., each component of an assembled finished good) is analyzed via a respective FMEA that represents the individual component. FMEAs of components that have a physical relationship to another component of the same system are modelled as superordinate or subordinate FMEAs of that component, depending on how they are related. A typical physical relationship is that a component is a sub-part of another component. For example, a handlebar is a mounted component of a door; the handlebar and door each have their own FMEAs which are related to each other.

In a structure net for a process or system FMEA, each system element is represented as a node, and no further elements (e.g., functions or failure modes) are visualized. Instead, as described below, functions are visualized in a separate functions net, and failure modes are visualized in a separate failure modes net.

The functions net of an FMEA includes the structure net along with a visualization of the functions of each system element. The functions of each system element can be related to functions of other system elements.

The failure modes net of an FMEA includes the structure net along with a visualization of the failure modes for each system element. Although the failure modes are direct elements of a function, they appear as direct elements of system elements in the structure net (i.e., because the functions are not visualized in the structure net).

The failure modes of a given system element can be related to failure modes of other system elements. From the perspective of a given FMEA, a failure mode that is related to a failure mode in a related superordinate FMEA is the cause of the failure mode in the related superordinate FMEA. Similarly, a failure mode of a given FMEA that is related to a failure mode in a related subordinate FMEA is an effect of the failure mode in the related subordinate FMEA. Accordingly, failure-cause-chains which span across multiple levels of system elements can be identified based on these relationships.

The full net of an FMEA refers to the structure net of the FMEA with the addition of the functions and failure modes of each system element of the FMEA.

An FMEA can be represented using a data model referred to as a directed graph. The directed graph representing a given FMEA can include different types of nodes, such as nodes representing system elements, functions, and failure modes. While existing software tools can generate visual representations of FMEAs using generic graph layouts, such tools fail to take into account the semantics of the various FMEA nodes. Further, such tools tend to place nodes in unexpected locations, and collapsing or expanding groups can lead to substantial layout changes. Accordingly, the layouts generated by such tools tend to have limited usability and can be difficult for end users to interpret. These issues can be especially problematic in the context of FMEAs, due to the complex nature of the associated methodology and the large size of many real-world FMEAs.

For example, existing software tools that use generic graph layouts to represent FMEAs tend to place nodes in an unordered manner, meaning the layout is mainly influenced by the relationships between the nodes rather than by the semantics of the nodes in the context of the FMEA.

Further, such tools may place nodes in an unstable manner, meaning that the addition of new nodes triggers an optimization of the layout in which the nodes are placed in unexpected locations. For example, in these circumstances, the tools may perform optimization of the layout to fulfil criteria which are not pertinent to FMEAs, which in turn can lead to unexpected node placements. Accordingly, nodes representing system elements are not always placed on top as expected, nodes representing functions are not placed in any alignment or formation, and nodes representing failure modes are not placed in any alignment or formation. Similarly, collapsing or expanding groups can lead to significant layout changes which are unexpected by the end user (e.g., movement of existing nodes to new positions).

### Example—Overview of Semantically-Aware Graphical Net Layouts for Visualization of FMEAs

Techniques are described herein for generating semantically-aware graphical net layouts for visualization of FMEAs. The disclosed semantically-aware layouts were developed based on the idea that optimizing for fewer overlapping edges is relatively unimportant in the context of FMEAs and does not solve the concern of unexpected node placements. Instead, the techniques described herein prioritize generation of a layout which is reasonable, expectable, and stable.

A reasonable layout for an FMEA refers to a layout in which nodes of the FMEA are positioned and grouped in accordance with a schema that reflects the internal structure of the FMEA. An expectable layout refers to a layout in which new nodes of the FMEA are placed according to the reasonable schema. A stable layout refers to a layout in which the relative position of each node of the FMEA is fixed. The disclosed techniques are based on the theory that if a layout of an FMEA and its nodes is reasonable, expectable, and stable, then a higher number of overlapping edges (as compared to edge-optimized layouts) is acceptable and not harmful for the user experience.

In accordance with the techniques described herein, a semantically-aware layout for an FMEA is generated based on semantic data regarding the FMEA. The layout can be a functions net, a failure net, or a full net layout. The semantic data specifies one or more groups of nodes, respective semantic group types of the one or more groups, respective semantic node types of the nodes, and relationships between the nodes.

Layout pre-processing is performed on the semantic data to generate a preliminary layout. The layout pre-processing can include performing graph traversal (e.g., breadth-first or depth-first graph traversal) on the semantic data to generate preliminary layout data for the FMEA. The preliminary layout data can specify relative positions of the one or more groups, relative positions of the nodes within the groups, and positions of edges relative to the nodes.

The semantic data and the preliminary layout data can be processed to generate processed (e.g., refined) layout data for the FMEA. The processing can include determining absolute positions for the nodes based on the preliminary layout data and the respective semantic node types of the nodes and determining absolute positions and geometries for the edges based on the preliminary layout data and the absolute positions for the nodes. A visual representation of a layout for the FMEA can be rendered based on the processed layout data and output for display via a user interface.

In the FMEA layouts generated via the disclosed techniques, the absolute positions for the nodes are determined such that the focus FMEA group is arranged at the center of the visual representation of the layout (e.g., unless the user scrolls away). Superordinate FMEAs are arranged on the left side of the focus FMEA, with a small offset downwards compared to the focus FMEA. Subordinate FMEAs are arranged on the right side of the focus FMEA, with a small offset downwards compared to the focus FMEA. Accordingly, the superordinate and subordinate FMEAs are arranged in the reading direction (i.e., from left to right) from the lowest element to the highest element. In other examples, a different relative configuration of the superordinate FMEAS, focus FMEA, and subordinate FMEAS may be used (e.g., an opposite configuration in which the superordinate FMEAs are arranged on the right side of the focus FMEA and the subordinate FMEAs are arranged on the left side of the focus FMEA).

Depending on the type of layout, each system element is placed in a group together with its functions and/or failure modes. Inside the group, the node representing the system element is centered above the nodes representing its functions (for a functions net or full net), or the nodes representing its failure modes (for a failure net).

For example, in the functions net layout, the absolute positions for the system element node and the function nodes of a given group are determined such that the system element node and the function nodes are arranged in a column, with the system element node centered above the function nodes in the visual representation. The function nodes are consistently sorted in order of creation time. Accordingly, nodes for functions that are added to the FMEA are appended to the bottom of the column of functions in the corresponding group.

In the failure net layout, the absolute positions for the failure modes of each system element are determined such that the system element node and the failure mode nodes are arranged in a column with the system element node centered above the failure mode nodes in the visual representation. The failure mode nodes are consistently sorted in order of creation time. Accordingly, nodes for failure modes that are added to the FMEA are appended to the bottom of the column of failure modes in the corresponding group.

In the full net layout, the absolute positions for the system element node and the function nodes of a given group are determined such that the system element node and the function nodes are arranged in a column with the system element node centered above the function nodes in the visual representation, as in the functions net layout. The absolute position for a given failure mode node in the full net layout is determined such that the given failure mode node is arranged below and rightward of the corresponding function node in the visual representation. In addition, the function nodes in a given group are sorted in order of creation time as in the functions net. The failure mode nodes for the functions of the given group are also sorted in order of creation time, such that later-created failure mode nodes for a given function are arranged below and to the right of earlier-created failure mode nodes for the given function. The relative arrangement of the function nodes and failure mode nodes in the full net layout is referred to herein as a cherry-on-tree formation.

The functions net layout, failure net layout, and full net layout can each include multiple levels of superordinate and/or subordinate FMEA groups, with the levels being arranged in respective columns. The FMEA groups in a given column have system elements which are semantically superordinate to the system elements of the FMEA groups in columns arranged to the right of the given column; similarly, the FMEA groups in a given column have system elements which are semantically subordinate to the system elements of the FMEA groups in columns arranged to the left of the given column.

The functions net layout, failure layout, and full net layout also include edges connecting nodes which are semantically related. The absolute position for a given edge can be determined such that the given edge originates at a first node, referred to as a source node for the given edge, and terminates at a second node, referred to as a target node for the given edge, in the visual representation of the layout. The geometry for a given edge can refer to whether the edge includes one or more 90° angles. An absolute position for a 90° angle in the given edge in the visual representation of the layout can be determined based on the absolute positions determined for the source and target nodes of the given edge.

The semantically-aware layouts can be generated by a software application (e.g., an FMEA application of a software platform) in accordance with the techniques described herein. Visual representations of the layouts can be rendered and displayed via a user interface.

### Example—Example System for Generating Semantically-Aware Graphical Net Layouts

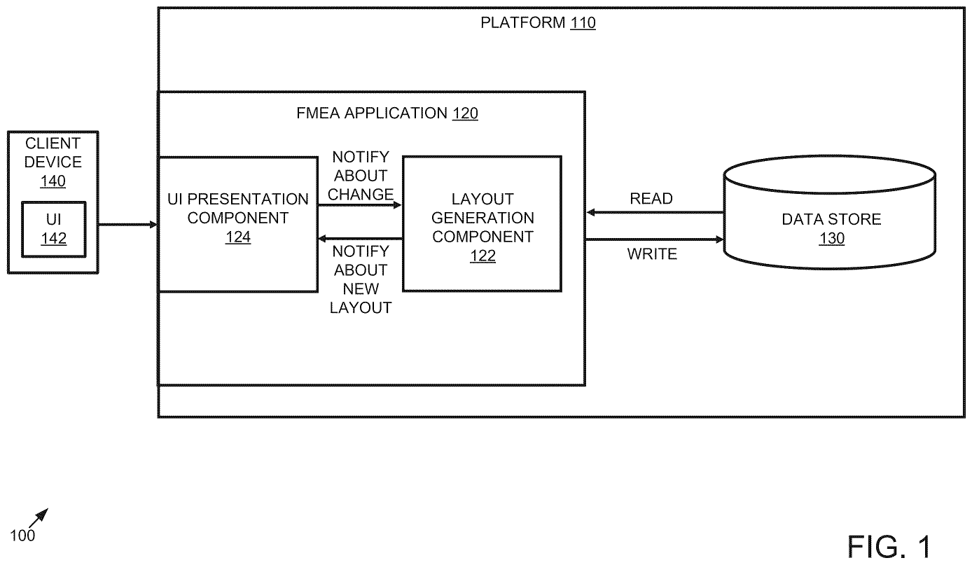

FIG. 1 is a block diagram of an example system 100 for generating semantically-aware graphical net layouts for visualization of FMEAs. In the example, the system 100 includes a platform 110 (e.g., a software platform), which in turn includes an FMEA application 120 and a data store 130. A client device 140 is configured to communicate and interact with the FMEA application 120 via a user interface (UI) 142.

The FMEA application 120 includes a layout generation component 122 and a UI presentation component 124. The layout generation component 122 can be configured to perform the techniques described herein for generating semantically-aware graphical net layouts based on semantic data regarding FMEAs. The semantic data regarding the FMEAs can include semantic data retrieved by the FMEA application 120 from the data store 130 (e.g., stored semantic data that was previously entered by a user of the FMEA application 120 and/or obtained from another source). Additionally, or alternatively, the semantic data regarding the FMEAs can be input by a user of the client device 140 via the UI 142, received by the UI presentation component 124, and relayed to the layout generation component 122.

For example, a user can input semantic data regarding a new FMEA (e.g., in conjunction with a request for the FMEA application 120 to generate a layout for the new FMEA). The UI presentation component 124 can intercept and relay the request and semantic data to the layout generation component 122, which in turn can generate a layout for the new FMEA in accordance with the techniques described herein. A visual representation of the layout can be rendered by the UI presentation component 124 for display to the user via the UI 142 of the client device 140.

As another example, a user can input semantic data regarding an update to an FMEA for which a layout has previously been generated by the FMEA application 120 (e.g., in conjunction with a request for the FMEA application 120 to generate a new layout which reflects the update to the FMEA). The UI presentation component 124 can intercept and relay the request and semantic data to the layout generation component 122, which in turn can generate a layout that reflects the update to the FMEA in accordance with the techniques described herein. For example, as shown in FIG. 1, the UI presentation component 124 can notify the layout generation component 122 about the change to the FMEA, and the layout generation component 122 can notify the UI presentation component 124 about the new (updated) layout after it is generated. A visual representation of the updated layout can be rendered by the UI presentation component 124 for display to the user via the UI 142 of the client device 140.

The semantic data used to generate the layout for a given FMEA can specify one or more groups of nodes, descriptive text for the respective nodes, a unique identifier, other FMEA-method-specific data, respective semantic group types of the one or more groups, respective semantic node types of the nodes, and relationships between the nodes. The semantic node types can include a system element node type, a function node type, and a failure mode node type. The semantic group types can include a focus FMEA group type, a superordinate FMEA group type, and a subordinate FMEA group type.

The descriptive text for the respective nodes can include labels for the respective nodes (e.g., text labels which describe the respective system elements, functions, and failure modes). The descriptive text for a given node can be displayed near the given node in the visual representation of the layout, as described further herein.

The other FMEA-method-specific data can include data pertaining to the FMEA methodology such as severity ratings of failure modes, administrative data (e.g., who created the FMEA and when they created the FMEA, who changed the FMEA and when they changed the FMEA, etc.). In some examples, certain other FMEA-method-specific data may not be relevant for the layout itself, but may be useful in real-world applications.

A given relationship between nodes that is specified in the semantic data can belong to one of the following three categories of relationships between nodes: (1) parent-child relationships that specify to which FMEA a system element node, function node, or failure mode node belongs; (2) subordinate-superordinate relationships between system element nodes that specify the process or system hierarchy; and (3) relates-to relationships between failure mode nodes of different FMEAs representing failure-cause-chains. Accordingly, for a given relationship between nodes, the semantic data can include an indication of which of the three categories applies to the given relationship and associated data (e.g., an indication that the given relationship is a parent-child relationship along with an indication of the corresponding FMEA, an indication that the given relationship is a subordinate-superordinate relationship between system element nodes along with an indication of which system element node is subordinate and which system element node is superordinate, or an indication that the given relationship is a relates-to relationship between failure mode nodes of different FMEAs along with an indication of the failure-cause chain for the failure mode nodes).

Any of the systems herein, including the system 100, can comprise at least one hardware processor and at least one memory coupled to the at least one hardware processor.

The system 100 can also comprise one or more non-transitory computer-readable media having stored therein computer-executable instructions that, when executed by the computing system, cause the computing system to perform any of the methods described herein.

In practice, the systems shown herein, such as system 100, can vary in complexity and specific structure, with additional functionality, more complex components, and the like. For example, the platform 110, the FMEA application 120, and the other components of system 100 can include additional sub-components and additional functionality. As another example, the UI presentation component 124 and/or the layout generation component 122 can instead be implemented as part of a browser application that runs on the client device 140, or as part of the UI 142 of the client device 140. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the semantic FMEA data, the semantically-aware layouts generated by the FMEA application 120, and the like can be stored in one or more computer-readable storage media or computer-readable storage devices. The technologies described herein can be generic to the specifics of operating systems or hardware and can be applied in any variety of environments to take advantage of the described features.

### Example—Example Semantically-Aware Functions Net Layout

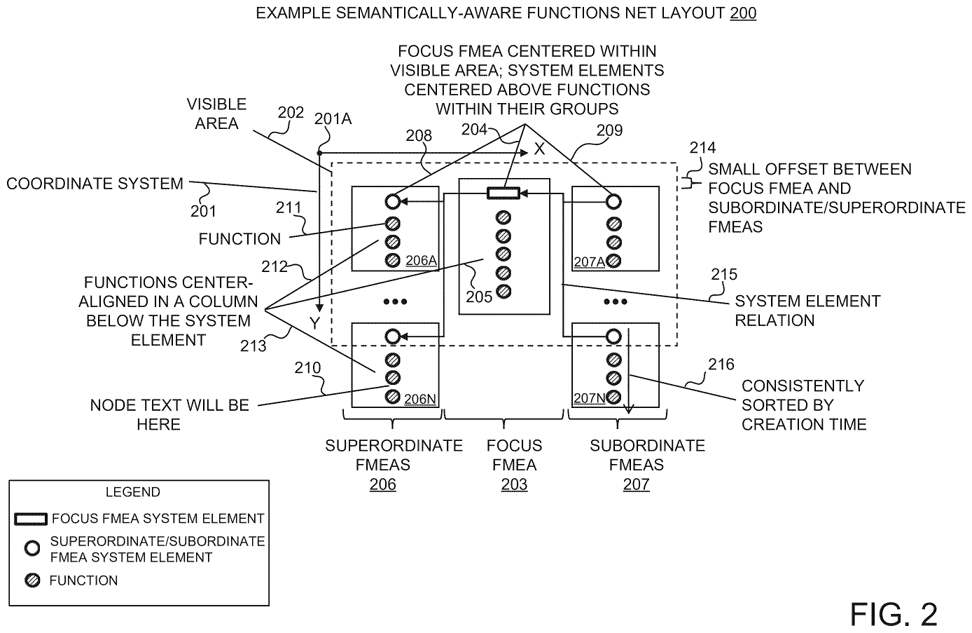

FIG. 2 is a block diagram of an example screen output showing a semantically-aware functions net layout 200 which may be generated as part of a semantically-aware graphical net layout for FMEA visualization in accordance with the techniques described herein. Functions net layout 200 includes annotations with explanations regarding various aspects. The functions net layout 200 may be generated by a software application such as FMEA application 120 of FIG. 1, and a visual representation of the functions net layout 200 can be displayed to a user via a UI. FIG. 2 also includes a legend which indicates the symbols used to represent the system elements, functions, and failure modes in the example.

For ease of explanation, a coordinate system 201 which indicates the orientations of the x-axis and y-axis is shown in FIG. 2. Coordinate system 201 can serve as a reference frame for placement of visual elements within the layout. An origin 201A of the coordinate system 201 is arranged at the top left corner of the layout. As shown, the x-coordinate values increase in the rightward direction and the y-coordinate values increase in the downward direction.

In the functions net layout 200, the functions are depicted as circles with diagonal striping. In practice, the functions can instead be depicted as colored circles (e.g., green circles). Alternatively, the functions may be represented by different symbols with different colors and/or patterns, or in another manner. The text describing a given function can be included within the symbol for the given function, adjacent to the symbol, or in some other relationship to the symbol which communicates to a user viewing the layout that the text is associated with the symbol.

A visible area 202 of the functions net layout 200 indicates a portion of the functions net layout 200 which is initially visible to a user viewing the functions net layout 200 via a UI. The functions net layout 200 includes a focus FMEA 203. As indicated at 204, the focus FMEA 203 is displayed in the center of the visible area 202; however, if the user scrolls or otherwise navigates away from the initial view (e.g., to view areas of the functions net layout 200 to the left or right of the visible area 202 (i.e., in the +/−X direction) or below the visible area 202 (i.e., in the +Y direction), the focus FMEA 203 may no longer be visible, or may no longer be displayed in the center of the visible area 202.

As indicated at 205, the functions within the focus FMEA 203, depicted as circles with diagonal striping, are center-aligned in a column below the system element of the focus FMEA, which is shown as an empty rectangle for ease of depiction. In practice, the rectangular symbol representing a system element of a focus FMEA can include text describing the focus FMEA (e.g., text within the rectangular symbol).

The functions net layout 200 further includes a plurality of superordinate FMEAs 206 (i.e., superordinate FMEAs 206A . . . 206N) and a plurality of subordinate FMEAs 207 (i.e., subordinate FMEAs 207A . . . 207N). As shown, the superordinate FMEAs 206 are arranged leftward of the focus FMEA 203 such that the topmost one of the superordinate FMEAs 206 (i.e., superordinate FMEA 206A) is offset downward relative to the focus FMEA 203. Similarly, as shown, the subordinate FMEAs 206 are arranged rightward of the focus FMEA 203 such that the topmost one of the subordinate FMEAs 207 (i.e., subordinate FMEA 207A) is offset downward relative to the focus FMEA 203.

The system element of superordinate FMEA 206A, depicted as an empty circle, is indicated at 208. The system element of subordinate FMEA 207A, depicted as an empty circle, is indicated at 209. In practice, as indicated at 210, the circular symbols representing nodes (e.g., system elements or functions) of a superordinate FMEA or subordinate FMEA can include adjacent descriptive text (e.g., text below the circular symbol and within a predefined distance from the bottom of the circular symbol). The descriptive text for respective nodes can be included in the semantic data, as described herein.

Alternatively, the system elements of the focus FMEA 203, the superordinate FMEAs 206, and/or the subordinate FMEAs 207 may be represented by different symbols with different colors and/or patterns, or in another manner. The text describing a given system element can be included within the symbol for the given system element, adjacent to the symbol, or in some other relationship to the symbol which communicates to a user viewing the layout that the text is associated with the symbol.

A function within the superordinate FMEA 206A is indicated at 211. As indicated at 212 and 213, the respective system elements of the superordinate FMEAs 206 and subordinate FMEAs 207 are centered above the functions within their respective FMEAs. Like the functions of the focus FMEA 203, the functions of the superordinate FMEAs 206 and the subordinate FMEAs 207 are depicted as circles with diagonal striping and center-aligned in a column below the corresponding system element.

While the functions net layout 200 includes multiple superordinate FMEAs 206 and multiple subordinate FMEAs 207, a functions net layout can alternatively include a single superordinate FMEA and/or a single subordinate FMEA. Similarly, the number of functions depicted in the focus FMEA 203 and in each of the superordinate FMEAs 206 and subordinate FMEAs 207 is merely an example; in practice, the number of functions in a given FMEA will vary depending on the complexity of the system element of the FMEA.

The superordinate FMEAs 206 are arranged on the left side of the focus FMEA 203, with a small offset downwards (i.e., in the +Y direction) as compared to the focus FMEA as indicated at 214. Subordinate FMEAs are arranged on the right side of the focus FMEA, with a small offset downwards as compared to the focus FMEA as indicated at 214. In addition, the superordinate and subordinate FMEAs are arranged in the reading direction (i.e., from left to right) from the lowest element to the highest element.

Relationships between the system elements of the focus FMEA 203, superordinate FMEA 206, and the subordinate FMEAs 207 are represented by lines connecting the system elements; the lines can alternatively be referred to as edges. An example edge representing a relation between the system element of the focus FMEA 203 and the system element of the subordinate FMEA 207N is indicated at 215.

As indicated at 216, the functions added to a given FMEA are consistently sorted by creation time, such that the function with the earliest creation time for the given FMEA is shown immediately below the system element for the given FMEA and the function with the latest creation time for the given FMEA is shown as the bottom-most function of the given FMEA. Accordingly, when a function is added to a given FMEA, it is always appended below the most recently added (and thus, bottom-most) function of the given FMEA.

While the functions net layout 200 only includes a single column of superordinate FMEAs 206 and a single column of subordinate FMEAs 207, a functions net can include multiple such columns in practice, as described further herein.

### Example—Example Semantically-aware Failure Net Layout

In accordance with the techniques disclosed herein, a semantically-aware failure net layout for an FMEA generally follows the same layout rules as the functions net layout 200 of FIG. 2, except that failure modes are visualized instead of functions. Like the functions net layout, the failure net layout may be generated by a software tool such as FMEA application 120 of FIG. 1 for display to a user via a UI. In the context of the FMEA methodology, failures may alternatively be referred to as failure modes.

In practice, colored circles (e.g., red circles) may be used to represent failure modes in the failure net layout. For example, the functions in a given layout may be shown as green circles, whereas the failure modes may be shown as red circles. Representing the functions and failure modes using contrasting colors like green and red can advantageously improve readability of the layout. Further, using green to represent the functions and red to represent the failure modes can further improve readability, as the colors green and red have certain connotations which are appropriate for the functions and failure modes, respectively.

Alternatively, different symbols, different colors, and/or different patterns can be used to represent the failure modes. In the examples described below, circles with a zig zag pattern are used to represent failure modes for ease of depiction.

### Example—Example Semantically-Aware Full Net Layout

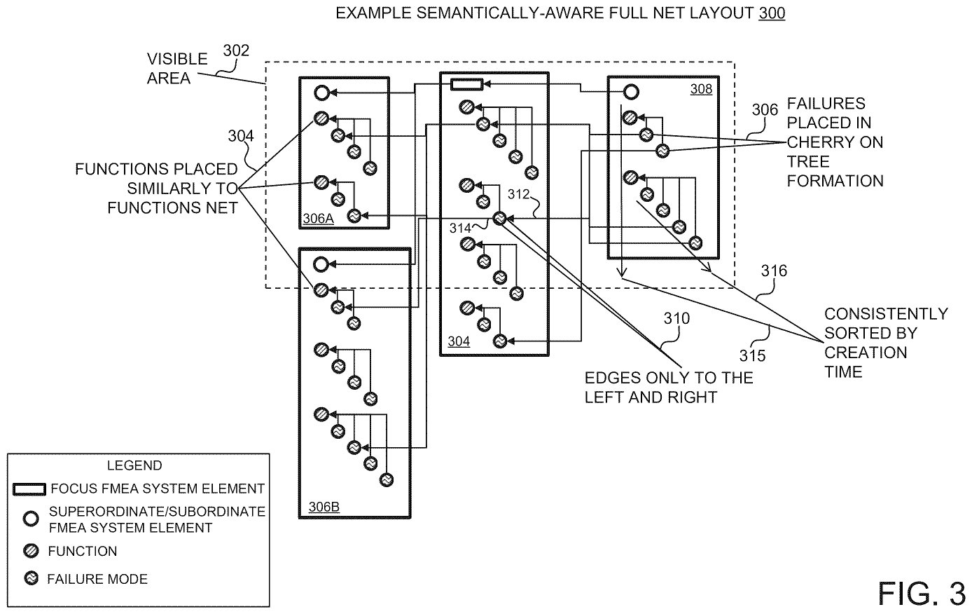

FIG. 3 is a block diagram of an example screen output showing a semantically-aware full net layout 300 which may be generated as part of a semantically-aware graphical net layout for FMEA visualization in accordance with the techniques described herein. Full net layout 300 includes annotations with explanations regarding various aspects. The full net layout 300 may be generated by a software tool such as FMEA application 120 of FIG. 1 and displayed to a user via a UI. FIG. 3 also includes a legend which indicates the symbols used to represent the system elements, functions, and failure modes in the example.

The full net layout 300 visualizes all nodes of each group, and thus can be understood as a combination of a structure net layout, a functions net layout, and a failure net layout. In general, the full net layout 300 conforms to the same conventions described above with reference to FIG. 2 regarding the relative positioning of the focus FMEA, superordinate FMEAs, subordinate FMEAs, and the other elements of the layout. Accordingly, the above description of the elements of functions net layout 200 is generally applicable to the full net layout 300. However, the positioning of the failure modes in the full net layout 300 differs from the positioning of the failure modes in the failure net layout described above in some regards, as described further below.

For ease of depiction, the functions are depicted as circles with diagonal striping and the failure modes are depicted as circles with a zig zag pattern in the full net layout 300. In practice, the functions and failure modes may instead be depicted as different-colored circles (e.g., the functions may be depicted as green circles, and the failure modes may be depicted as red circles). Alternatively, the functions and failure modes may be represented by different symbols with different colors and/or patterns, or in another manner. The text describing a given function or failure mode can be included within the symbol for the given function or failure mode, adjacent to the symbol, or in some other relationship to the symbol which communicates to a user viewing the layout that the text is associated with the symbol.

A visible area 302 of the full net layout 300 indicates a portion of the full net layout 300 which is initially visible to a user viewing the full net layout 300 via a UI. In the example, the full net layout includes a focus FMEA 304, a first superordinate FMEA 306A, a second superordinate FMEA 306B, and a single subordinate FMEA 308. In other examples, a different number of superordinate FMEAs (e.g., 0, 1, or more superordinate FMEAs) and/or a different number of subordinate FMEAs (e.g., 0, 1, or more subordinate FMEAs) may be included in the full net layout 300.

As indicated at 304, the full net layout 300 includes a plurality of functions placed similarly to the functions in the functions net layout (e.g., functions net layout 300). Further, as indicated at 306, the full net layout 300 includes a plurality of failure modes placed in a configuration referred to as a cherry-on-tree formation. In this configuration, the assigned failure modes for a given function are placed below the given function along a sloped line having an angle of approximately 45°.

In particular, the absolute position of a given failure mode node is arranged at a downward offset relative to the absolute position of the corresponding function node; the size of the downward offset can be at least the height of (e.g., equal to or greater than the height of) a symbol representing the failure mode node in the visual representation of the layout, to avoid overlaps or placements that are too narrow. Further, the absolute position of the given failure mode node is arranged at a rightward offset relative the absolute position of the corresponding function node; the size of the rightward offset is at least the width of (e.g., equal to or greater than the width of) the symbol representing the failure mode node in the visual representation of the layout.

Arranging the failure modes in the cherry-on-tree formation achieves several purposes. For example, when this configuration is used, all failure modes that belong to a given function are connected to the given function by respective vertical edges which converge at a horizontal edge connected to the right side of the given function. Accordingly, failure modes and their associated parent function are visually grouped without being placed in an actual group (e.g., without being depicted within a bounding box). This in turn supports readability and orientation.

As another example, when the cherry-on-tree formation is used to depict the failure modes, the edges running from the failure modes to their parent functions can be visualized with minimal overlap with other edges and no overlap with other nodes.

Further, as indicated at 310, edges running from a given failure mode to other failure modes can only be placed to the left and to the right of the given failure mode when the cherry on tree configuration is used. This can advantageously reduce possible overlaps of edges. For example, in the full net layout 300, an example edge 312 represents a relationship between the second failure mode of the second function of the focus FMEA 304 and three of the failure modes of the subordinate FMEA 308 (i.e., the first failure mode of the first function of the subordinate FMEA 308 and the third and fourth failure modes of the second function of the subordinate FMEA 308). An example edge 314 represents a relationship between the second failure mode of the second function of the focus FMEA 304 and the first failure mode of the first function of the superordinate FMEA 306B.

As indicated at 315 and 316, the functions and failure modes added to a given FMEA are consistently sorted by creation time. For example, as in the functions net layout 200, the function with the earliest creation time for the given FMEA is shown immediately below the system element for the given FMEA and the function with the latest creation time for the given FMEA is shown as the bottom-most function of the given FMEA. The failure modes for a given function within an FMEA are also consistently sorted by creation time, such that later-created failure modes for a given function are arranged below and to the right of earlier-created failure modes for the given function.

While the full net layout 300 only includes a single column of superordinate FMEAs and a single column of subordinate FMEAs, a full net layout can include another number of columns of superordinate FMEAs and/or subordinate FMEAs in practice (e.g., 0, 1, or more columns of superordinate FMEAs and 0, 1, or more columns of subordinate FMEAs).

### Example—Example Method for Generating a Semantically-Aware Graphical Net Layout for an FMEA

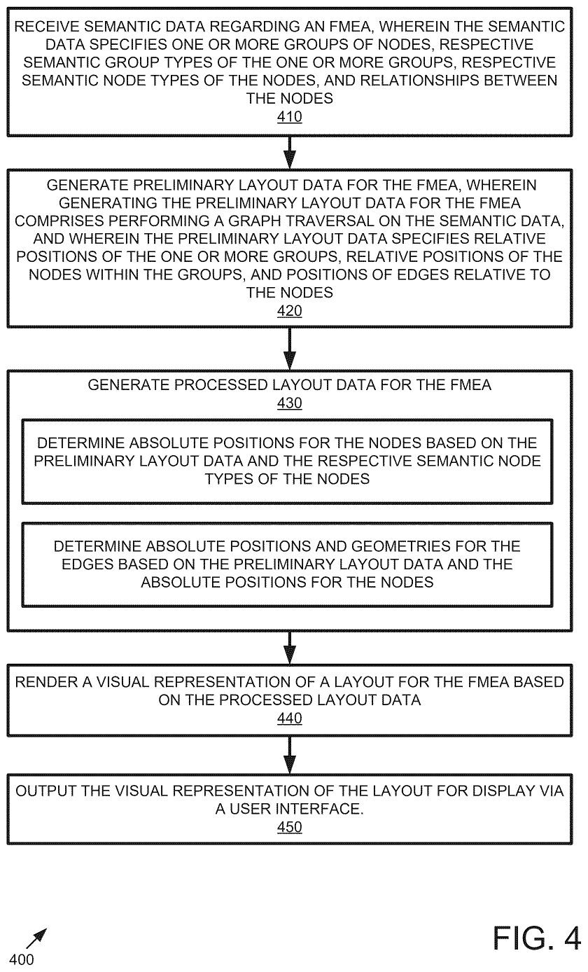

FIG. 4 is a flowchart of an example method 400 of generating a semantically-aware graphical net layout for an FMEA and can be performed, for example, by the system of FIG. 1. The layout generated by the example method 400 can be a full net layout for the FMEA, a functions net layout for the FMEA, or a failure mode net layout for the FMEA, for example.

In the example, at 410, semantic data regarding an FMEA is received. The semantic data can specify one or more groups of nodes, respective semantic group types of the one or more groups, respective semantic node types of the nodes, and relationships between the nodes. As described herein, a given FMEA can include a focus FMEA, which is the subject of the overall FMEA, along with include associated superordinate FMEAs and/or subordinate FMEAs.

At 420, preliminary layout data for the FMEA is generated. Generating the preliminary layout data for the FMEA can include performing a graph traversal (e.g., breadth-first or depth-first graph traversal) on the semantic data. The preliminary layout data can specify relative positions of the one or more groups, relative positions of the nodes within the groups, and positions of edges relative to the nodes. In some examples, other pre-processing steps are performed at this stage in addition to the graph traversal. An example layout pre-processing technique is described below with reference to FIG. 6.

At 430, processed layout data for the FMEA is generated. Generating the processed layout data for the FMEA can include determining absolute positions for the nodes based on the preliminary layout data and the respective semantic node types of the nodes. The absolute position of a given node can refer to x- and y-coordinates of the given node in a two-dimensional coordinate plane. As described above with reference to FIG. 2, the origin of the coordinate plan is located at the top left corner, relative to which x-coordinate values increase in the rightward direction and y-coordinate values increase in the downward direction.

In some examples, the absolute positions for the nodes in the top-leftmost group of the preliminary layout are determined first. After the absolute positions for these nodes have been determined, the absolute position and size of a box bounding the nodes of the top-leftmost group can be determined. If there are any other groups in the same column as the top-leftmost group, the absolute positions for the nodes of the group directly below the top-leftmost group can be determined next, and so on, until the absolute positions of the nodes in all groups in that column have been determined. The absolute positions of the nodes in the top group of the next column to the right can be determined next, followed by the absolute positions for the nodes of the group directly below that group. The absolute positions of the nodes, and optionally the positions and sizes of the boxes bounding the groups, can continue to be determined until the absolute positions of the nodes of the bottom-rightmost group have been determined.

Generating the processed layout data for the FMEA can further include determining absolute positions and geometries for the edges based on the preliminary layout data and the absolute positions for the nodes. For example, after the absolute positions of the nodes (and optionally, the absolute positions and sizes of the bounding boxes) have been determined, the absolute positions and geometries for the edges connecting the nodes can be determined. The determination can be performed for the edge whose source node is closest to the origin, and then for the edge whose source node is next-closest to the origin, and so on until the determination has been performed for all the edges. Alternatively, the absolute positions and geometries for the edges can be determined in a different order.

In some examples, the geometry for a given edge is determined first. Determining the geometry of the given edge can include determining an absolute position (i.e., the x-and y-coordinate position) at which the given edge needs to have a 90° angle in order to connect the corresponding source node and target node. Accordingly, this determination can be based on the absolute positions for the source and target nodes of the given edge. Depending on where the source and target nodes are positioned, the geometry of the given edge may need to have multiple 90° angles in order to connect the source and target nodes; in such examples, determining the geometry for the given edge can include determining the absolute positions of the multiple 90° angles.

For example, the geometry of an edge between a failure mode node and its function mode can be determined by first determining the absolute positions (i.e., the x- and y-coordinate positions) of the starting point of the edge, the end point of the edge, and each point of the edge at which there should be a 90° degree angle. After the absolute positions of these points are determined, the edge can be visualized by adding a line to the layout which connects the points in the following order: (1) the starting point, (2) the 90°-degree-angle-point, and (3) the end point, for example. Here, the starting point is the center of the failure mode node, the end point is the center of the function node, the x-coordinate of the 90°-angle-point is the x-coordinate of the failure mode node, and the y-coordinate is the y-coordinate of the function node.

At 440, a visual representation of a layout for the FMEA is rendered based on the processed layout data. For example, a UI presentation component of an FMEA application such as UI presentation component 124 of FIG. 1 can render the visual representation of the layout. In the visual representation of the layout, the function node(s) of a given group can be centered below the system element node of the given group, the failure mode node(s) of the given group can be arranged below and rightward of the corresponding function node(s) of the given group in a cherry-on-tree formation, and the respective nodes can be labeled with the corresponding descriptive text from the semantic data.

At 450, the visual representation of the layout is output for display via a UI (e.g., UI 142 of FIG. 1).

The method 400 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving data can be described as sending data depending on perspective.

### Example—Example Technique for Determining the Geometry of Edges Connecting Failure Mode Nodes

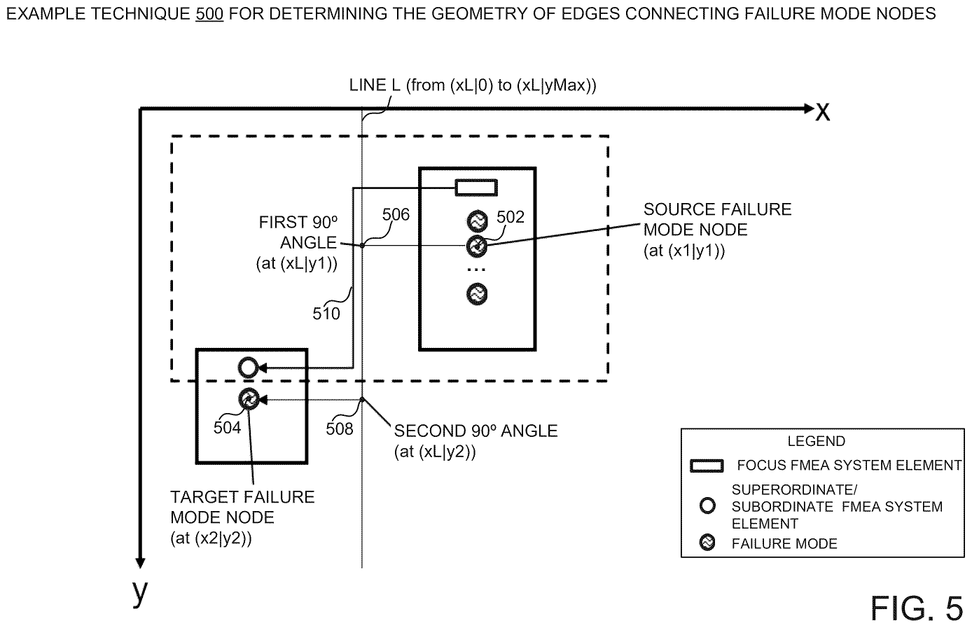

FIG. 5 is a block diagram showing an example technique 500 for determining the geometry of edges connecting failure mode nodes and can be used in any of the examples herein. The technique 500 can be performed by a software application such as FMEA application 120 of FIG. 1.

A relatively simplistic example is shown in FIG. 5 for ease of explanation. In the example, the geometry of an edge connecting two failure mode nodes is determined for an example failure net layout; in other examples, the technique 500 can be performed in the context of other types of layouts that include failure modes such as full net layouts. In practice, the FMEA may include a different number of nodes, groups, superordinate levels, and/or subordinate levels than what is shown in FIG. 5. FIG. 5 also includes a legend which indicates the symbols used to represent the system elements and failure modes in the example. In the example, the notation (x|y) describes the x- and y-coordinates of a point, and yMax represents the greatest possible value for y.

The geometry of an edge between two failure mode nodes can be determined in a similar manner to the determination of the geometry of an edge between a failure mode node and its function mode, with the addition of determining one additional point for a 90° angle. The starting point is the center of the source failure mode node at absolute position (x1|y1) (indicated at 502) and the end point is the center of the target failure mode node (x2|y2) (indicated at 504). The x-coordinate of the first 90°-degree-angle-point (indicated at 506) is the x-coordinate of an imagined line L which extends from (xL|0) to (xL|yMax), i.e., xL. The y-coordinate of the first 90°-degree-angle-point is the y-coordinate of the source failure mode node, i.e., y1. Accordingly, the absolute position of the first 90°-degree-angle-point is (xL|y1). In the example, the imagined line L sits exactly in the center between the group where the source failure node is located and the group where the target failure mode is located; alternatively, the imagined line L can be placed at another location in-between those two groups. The x-coordinate of the second 90°-angle-point (indicated at 508) is the x-coordinate of the imagined line L (i.e., xL) and the y-coordinate of the second 90°-angle-point is the y-coordinate of the target failure node (i.e., y2); accordingly, the absolute position of the second 90°-degree-angle-point is (xL|y2).

For illustrative purposes, consider an example in which xL=10 and yMax=100, such that the imagined line L extends from (10|0) to (10|100). In the example, x1=15, y1=5, x2 =5, and y2=10. Accordingly, the absolute position of the center of the source failure node is (15|5), and the absolute position of the center of the target failure node is (5|10). In accordance with technique 500, the absolute position of the first 90°-angle-point can be determined as (xL|y1), i.e., (10|5), and the absolute position of the second 90°-angle-point can be determined as (xL|y2), i.e., (10|10).

The geometry of an edge between system element nodes can be constructed in a similar manner, except that an imagined line L1 can be considered instead of the imagined line L. The imagined line L1 can be positioned at a visually reasonable small distance from the imagined line L (e.g., at x-coordinate positions which differ by an amount greater than a first threshold and less than a second threshold, such that L and L1 are close together but do not overlap). For example, in FIG. 5, an edge connecting system elements is indicated at 510. As shown, a vertical portion of this edge (at the x-coordinate of the imagined line L1) is slightly offset to the left of the vertical portion of the edge connecting the failure mode nodes (at the x-coordinate of the imagined line L).

### Example—Example Layout Pre-Processing Technique

FIG. 6 is a block diagram showing an example layout pre-processing technique 600 for generating a preliminary layout of an FMEA and can be used in any of the examples herein. The technique 600 employs a graph traversal method on semantic data regarding the FMEA, along with other pre-processing steps, to produce preliminary layout data for the FMEA. The technique 600 can be performed by a software application such as FMEA application 120 of FIG. 1. A relatively simplistic example is shown in FIG. 6 for ease of explanation. In practice, the FMEA may include a different number of nodes, groups, superordinate levels, and/or subordinate levels than what is shown in FIG. 6. FIG. 6 also includes a legend which indicates the symbols used to represent the system elements, functions, and failure modes in the example.

Graph traversal refers to a process in which all vertices (e.g., nodes) and edges in a graph are visited systematically. Some example existing graph traversal approaches include are breadth-first traversal and depth-first traversal. In the breadth-first traversal technique, a graph is systematically explored layer by layer, beginning at a specified starting node. The breadth-first traversal technique examines all nodes at a given distance from the starting node before moving to nodes located further from the starting node, until all reachable nodes have been visited. In the depth-first traversal technique, each branch of a graph is explored as deeply as possible before the technique backtracks to explore alternative branches, until all reachable nodes have been visited. Alternatively, other graph traversal techniques such as bidirectional search may be used to generate the preliminary layout data.

The technique 600 performs breadth-first traversal on semantic data regarding the FMEA. The semantic data regarding the FMEA specifies one or more groups of nodes of the FMEA, respective semantic group types of the one or more groups, respective semantic node types of the nodes, and relationships between the nodes. The semantic group types can include a focus FMEA group type, a superordinate FMEA group type, and a subordinate FMEA group type. The semantic types of the nodes can include a system element node type, a function node type, and a failure mode node type.

In the example, the groups of nodes specified in the semantic data regarding the FMEA include a group of the focus FMEA group type which includes a node SE1 of the system element node type, a node FU1 of the function node type, and nodes FM1 and FM2 of the failure mode node type. The groups of nodes specified in the semantic data further include three groups of the superordinate FMEA group type which include respective nodes of the system element node type (SE2, SE3, and SE6); each of these groups includes three nodes of the function node type. The groups of nodes specified in the semantic data further include three groups of the subordinate FMEA group type which include respective nodes of the system element node type (SE4, SE5, and SE7); each of these groups includes three nodes of the function node type.

Further, in the example, the relationships between the nodes specified in the semantic data regarding the FMEA include respective superordinate relationships between the nodes SE2 and SE1, the nodes SE3 and SE1, and the nodes SE6 and SE2, and respective subordinate relationships between the nodes SE4 and SE1, the nodes SE5 and SE1, and the nodes SE7 and SE4. The relationships between the nodes specified in the semantic data further include respective relationships between each node of the function node type and a corresponding one of the nodes of the system element node type; these relationships indicate that the nodes of the function node type are functions of the corresponding node of the system element node type. In addition, the relationships between the nodes specified in the semantic data further include respective relationships between the nodes FU1 and FM1 and the nodes FU1 and FM2 which indicate that the nodes FM1 and FM2 represent failure modes associated with the function represented by the node FU1.

During the breadth-first traversal, the technique 600 systematically explores the semantic data, beginning with the system element node of the focus FMEA group (SE1 in the example). The technique 600 then examines all nodes at a given distance from the starting node before moving to nodes located further from the starting node, until all reachable nodes have been visited. During this process, the technique 600 determines relative positions of the groups, relative positions of the nodes within the groups, and positions of edges relative to the nodes; these positions are also referred to as preliminary layout data for a preliminary layout of the FMEA. The determination of the relative positions of the groups, nodes, and edges can take into account the relationships between the nodes and the semantic types and creation times of the groups and nodes. The relative positions can indicate where the groups, nodes, and edges, should be placed relative to one another (e.g., whether a given group is to the left of, to the right of, above, or below another group, which group a given node should be disposed in, and which nodes a given edge should connect), as opposed to x- and y-coordinate positions for these elements which are determined in a subsequent step.

Accordingly, determining the relative positions of the groups can include assigning the focus FMEA group to a centermost level referred to as level 0 of the preliminary layout, assigning the superordinate group(s) to one or more superordinate (upper) levels of the preliminary layout, and assigning the subordinate group(s) to one or more subordinate (lower) levels of the preliminary layout. The level to which a given group is assigned can be based on the relationship of the system element of the given group to the other system elements of the FMEA (i.e., the relationship between the node of the system element type of the given group and other nodes of the system element type of the FMEA). The relative positions of the groups within a given level can be determined based on their creation times, e.g., such that earlier-created groups are arranged above later-created groups within the given level.

In the example, the superordinate groups including the system elements SE2 and SE3, respectively are assigned to a first superordinate level (i.e., as SE2 and SE3 are each superordinate to SE1), and the superordinate group SE6 is assigned to a second superordinate level (i.e., as SE6 is superordinate to SE2). The subordinate groups SE4 and SE5 are assigned to a first subordinate level (i.e., as SE4 and SE5 are each subordinate to SE1), and the subordinate group SE7 is assigned to a second subordinate level (i.e., as SE7 is subordinate to SE4). The superordinate group including SE2 has an earlier creation time than the superordinate group including SE3, and thus is arranged above it within the first superordinate level. Similarly, the subordinate group including SE4 has an earlier creation time than the subordinate group including SE5, and thus is arranged above it within the first subordinate level.

Determining the relative positions of the nodes within a given group in the preliminary layout can include determining a vertical order of the nodes within the given group based on their semantic node types, their relationships with one another, and optionally, their creation times. For example, the relative positions of the nodes within the given group can be determined such that the system element node is arranged above all other nodes of the given group (i.e., at the top) in the preliminary layout, with function nodes arranged below the system element node in order of their creation times (i.e., such that earlier-created function nodes are above later-created function nodes). Similarly, the relative positions of failure mode nodes in the preliminary layout can be determined such that the failure mode nodes associated with a given function node are arranged below the given function node, and above any function nodes of the same group that were created later than the given function node. When a given function node has multiple failure modes, the relative positions of the failure modes nodes in the preliminary layout can be determined such that earlier-created failure mode nodes are arranged above later-created failure mode nodes.

In examples where node creation times factor into the determination of the relative positions of the nodes, child nodes can be sorted by creation time whenever a child node is selected. Alternatively, creation time may not factor into the determination of the relative positions of the nodes or the groups during the layout pre-processing stage; in such examples, creation time can instead factor into the subsequent determination of the absolute positions of the nodes. In other examples, creation time can be used to determine relative positions during layout pre-processing as well as absolute positions during the subsequent processing. As used herein, creation time can refer to a time and date when a given node was selected for inclusion in an FMEA (e.g., by a user of an FMEA application via input to a UI, or in another manner).

Determining the positions of edges relative to the nodes can include determining source and target nodes for a plurality of edges. For example, after the graph traversal has been performed, the technique 600 can identify source and target nodes for edges based on the relationships between nodes specified in the semantic data; the source and target nodes for the edges can be specified in the preliminary layout data. A given edge can represent a relationship between a first node (source node) and a second node (target node). For example, as shown in FIG. 6, an edge connects source node SE1 to target node SE2. Edges can also represent relationships between nodes within a given group, such as the edge between nodes FM1 and FU1 and the edge between nodes FM2 and FU1 shown in FIG. 6. As described herein, the absolute positions (e.g., coordinates) of the edges and the geometries of the edges (e.g., whether a given edge has a 90° angle in the visual representation of the layout) are determined during further processing and not during the layout pre-processing phase.

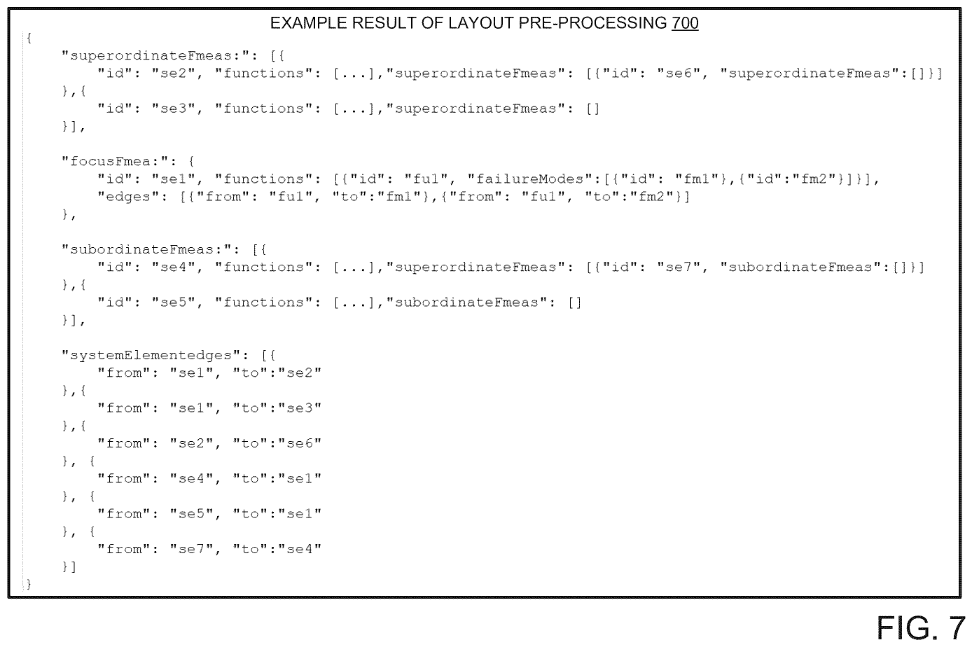

The preliminary layout data generated via technique 600 be formatted as a data structure for further processing by an FMEA application (e.g., FMEA application 120 of FIG. 1). An example data structure 700 comprising preliminary layout data that may be generated by the technique 600 is shown in FIG. 7. In the example, the data structure is a JSON object; other types of data structures can also be used.

As shown, the data structure 700 specifies details regarding the superordinate FMEA groups, the focus FMEA group, the subordinate FMEA groups and the system element edges in a structured data format. The details for a given group include an identifier of the system element for the group, a listing of any functions of the group, a listing of any failure modes for each function, and a listing of any internal edges of the group (i.e., edges connecting nodes within the given group). The details regarding the system element edges specify the source (“from”) system element node and target (“to”) node for each edge connecting system element nodes.

Certain contents of the data structure 700 are omitted for the sake of brevity, as indicated by ellipses (e.g., listing of the functions of the subordinate and superordinate FMEAs is omitted).

As described herein, the preliminary layout data in the data structure 700 can be processed to generate processed layout data, which in turn can specify absolute positions for nodes of the FMEA as well as absolute positions and geometries for edges of the FMEA. A visual representation of the layout can be rendered and output for display via a UI.

### Example—Example Semantically-Aware Graphical Net Layout

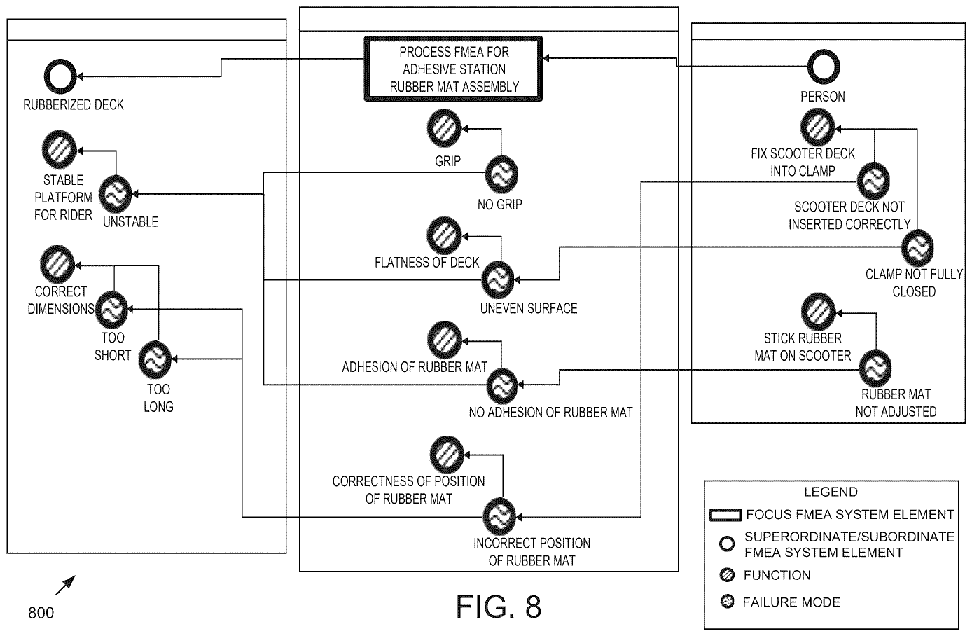

FIG. 8 is a block diagram of an example screen output showing a semantically-aware layout 800 that can be generated by an FMEA application, such as FMEA application 120 of FIG. 1, using the techniques described herein. The layout 800 is a full net layout which depicts a process FMEA for an adhesive station used during assembly of a rubber mat of an electric scooter, as indicated by the system element of the focus FMEA group at the center of the layout (labeled “PROCESS FMEA FOR ADHESIVE STATION RUBBER MAT ASSEMBLY”). The layout 800 may be generated by a software application such as FMEA application 120 of FIG. 1, and a visual representation of the layout 800 can be displayed to a user via a UI. FIG. 8 also includes a legend which indicates the symbols used to represent the system elements, functions, and failure modes in the example.

In the example, the process FMEA includes a single superordinate FMEA group for a rubberized deck system element (as indicated by the system element of the superordinate FMEA group labeled “RUBBERIZED DECK”), which pertains to a rubberized deck of the electric scooter which includes the rubber mat. In accordance with the techniques described herein, the superordinate group is positioned to the left of the focus FMEA group, with a downward offset relative to the focus FMEA group. An edge which includes a single 90° angle connects the system element node of the focus FMEA group to the system element of the superordinate FMEA group.

The process FMEA further includes a single subordinate FMEA group for a person system element (labeled “PERSON”), which pertains to actions performed by a person assembling certain portions of the electric scooter. In accordance with the techniques described herein, the subordinate group is positioned to the right of the focus FMEA group, with a downward offset relative to the focus FMEA group. An edge which includes a single 90° angle connects the system element node of the focus FMEA group to the system element of the subordinate FMEA group.

As shown, the focus FMEA group, the superordinate FMEA group, and the subordinate FMEA group each include multiple function nodes centered below the corresponding system element. In the example, one or more failure modes are arranged below and to the right of each function in a cherry-on-tree formation in accordance with the techniques described herein. The relative vertical positions of the function nodes with each group reflect their creation times, as do the relative vertical and horizontal positions of the failure mode nodes for the function which includes multiple failure modes (i.e., the correct dimensions function node of the superordinate FMEA group).

The layout includes edges that connect the failure modes with the corresponding function nodes within each group. In addition, the layout includes edges that connect failure modes of different groups which share a semantic relationship. For example, the depicted edges indicate that the “TOO SHORT” and “TOO LONG” failure modes of the “CORRECT DIMENSIONS” function of the superordinate FMEA group have a superordinate relationship to the “INCORRECT POSITION OF RUBBER MAT” failure mode of the “CORRECTNESS OF POSITION OF RUBBER MAT” function of the focus FMEA group. The depicted edges also indicate that the “INCORRECT POSITION OF RUBBER MAT” failure mode has a superordinate relationship to the “SCOOTER DECK NOT INSTALLED CORRECTLY” failure mode of the subordinate FMEA group.

As demonstrated by the layout 800, the techniques described herein achieve a layout which clearly communicates the various semantic relationships between the FMEA nodes, with minimal overlapping of edges. For example, it is easy for an end user to recognize that the failure mode “UNSTABLE” of the function “STABLE PLATFORM FOR RIDER” of the FMEA for “RUBBERIZED DECK” can be caused by either failure mode “NO GRIP” of function “NO GRIP,” failure mode “UNEVEN SURFACE” of function “FLATNESS OF DECK,” or failure mode “NO ADHESION OF RUBBER MAT” of function “ADHESION OF RUBBER MAT,” each of which are part of the focus FMEA that includes the system element “PROCESS FMEA FOR ADHESIVE STATION RUBBER MAT ASSEMBLY.” Put another way, it is easy to recognize that the failure mode “UNSTABLE” is an effect of the aforementioned failure modes. Furthermore, it is intuitively clear which failure modes belong to which function, and which functions belong to which FMEA. Moreover, it is intuitively clear which FMEAs are superordinate or subordinate to the focus FMEA and which is the focus FMEA. Newly added elements, e.g., a new failure mode or function, can be added according to the previously described rules; accordingly, the relative positions of the other nodes can be kept stable such that the end-user will not be distracted by drastic changes in the layout after the addition.

### Example—Use Cases

The technologies described herein can be applied in a variety of scenarios.

As one example, the technologies can be integrated into on-premises or cloud software associated with platforms such as SAP S/4HANA, SAP S/4HANA Cloud Private Edition, or SAP S/4HANA Cloud Public Edition available from SAP SE of Walldorf, Germany. For example, such a platform can include an FMEA application such as FMEA application 120 of FIG. 1 (e.g., as a standalone application or as part of another software application of the platform).

### Example—Example Implementations

Any of the following can be implemented.

Clause 1. A computer-implemented method comprising: receiving semantic data regarding a Failure Mode and Effects Analysis (FMEA), wherein the semantic data specifies one or more groups of nodes, respective semantic group types of the one or more groups, respective semantic node types of the nodes, and relationships between the nodes; generating preliminary layout data for the FMEA, wherein generating the preliminary layout data for the FMEA comprises performing a graph traversal on the semantic data, and wherein the preliminary layout data specifies relative positions of the one or more groups, relative positions of the nodes within the groups, and positions of edges relative to the nodes; generating processed layout data for the FMEA, wherein generating the processed layout data for the FMEA comprises: determining absolute positions for the nodes based on the preliminary layout data and the respective semantic node types of the nodes; and determining absolute positions and geometries for the edges based on the preliminary layout data and the absolute positions for the nodes; rendering a visual representation of a layout for the FMEA based on the processed layout data; and outputting the visual representation of the layout for display via a user interface.

Clause 2. The method of Clause 1, wherein: the semantic node type of a given one of the nodes is selected from the group consisting of: a system element node type; a function node type; and a failure mode node type; and the semantic group type of a given group of the one or more groups is selected from the group consisting of: a focus FMEA group type; a superordinate FMEA group type; and a subordinate FMEA group type.

Clause 3. The method of Clause 2, wherein: the one or more groups comprise a single focus FMEA group of the focus FMEA group type; and the absolute positions for the nodes are determined such that the focus FMEA group is arranged at a center of the visual representation of the layout.

Clause 4. The method of Clause 3, wherein: the one or more groups further comprise one or more superordinate FMEA groups of the superordinate FMEA group type; and the absolute positions for the nodes are determined such that the one or more superordinate FMEA groups are arranged leftward of the focus FMEA group, and such that a topmost one of the one or more superordinate FMEA groups is offset downward relative to the focus FMEA group.

Clause 5. The method of Clause 3 or Clause 4, wherein: the one or more groups further comprise one or more subordinate FMEA groups of the subordinate FMEA group type; and the absolute positions for the nodes are determined such that the one or more subordinate FMEA groups are arranged rightward of the focus FMEA group, and such that a topmost one of the one or more superordinate FMEA groups is offset downward relative to the focus FMEA group.

Clause 6. The method of any one of Clauses 2-5, wherein: the given group comprises a single system element node of the system element node type and one or more function nodes of the function node type; and the absolute positions for the system element node and the one or more function nodes are determined such that the system element node and the one or more function nodes are arranged in a column with the system element node centered above the one or more function nodes in the visual representation of the layout.

Clause 7. The method of Clause 6, wherein: the given group further comprises one or more failure mode nodes of the failure mode node type, wherein a given failure mode node of the one or more failure mode nodes represents a failure mode of a given function node of the one or more function nodes; and the absolute position for the given failure mode node is determined such that the given failure mode node is arranged below and rightward of the given function node in the visual representation of the layout.

Clause 8. The method of Clause 7, wherein: a downward offset of the absolute position of the given failure mode node relative to the absolute position of the given function node is equal to or greater than a height of a symbol representing the failure mode node type in the visual representation of the layout; and a rightward offset of the absolute position of the given failure mode node relative to the absolute position of the given function node is equal to or greater than a width of the symbol representing the failure mode node type in the visual representation of the layout.

Clause 9. The method of Clause 7 or Clause 8, wherein: the given failure mode node is a first failure mode node of the given group; the one or more nodes of the given group further comprise a second failure mode node of the failure mode node type, wherein the second failure mode node represents another failure mode of the given function node; and the absolute position for the second failure mode node is determined such that the second failure mode node is arranged below and rightward of the first failure mode node.

Clause 10. The method of Clause 9, wherein: a downward offset of the absolute position of the second failure mode node relative to the absolute position of the given failure mode node is equal to or greater than a height of a symbol representing the failure mode node type in the visual representation of the layout; and a rightward offset of the absolute position of the second failure mode node relative to the absolute position of the first failure mode node is equal to or greater than a width of the symbol representing the failure mode node type in the visual representation of the layout.

Clause 11. The method of any one of Clauses 2-10, further comprising: receiving data specifying respective creation times of the nodes, wherein the determination of the absolute positions for the nodes is further based on the creation times of the nodes.

Clause 12. The method of Clause 11, wherein: the nodes of the given group comprise a plurality of function nodes of the function node type and a plurality of failure mode nodes of the failure mode node type; the function nodes of the given group are arranged in order of their creation times such that those with earlier creation times are arranged above those with later creation times in the visual representation of the layout; and the failure mode nodes of a given one of the function nodes of the given group are arranged in order of their creation times such that those with earlier creation times are arranged above those with later creation times in the visual representation of the layout.

Clause 13. The method of any one of Clauses 2-12, wherein: the one or more groups comprise a plurality of superordinate FMEA groups of the superordinate FMEA group type and a plurality of subordinate FMEA groups of the subordinate FMEA group type; the superordinate FMEA groups are arranged in at least a first superordinate column and a second superordinate column arranged to leftward of the first superordinate column in the visual representation of the layout, wherein a given one of the superordinate FMEA groups in the second superordinate column is semantically superordinate to a given one of the superordinate FMEA groups in the first superordinate column; and the subordinate FMEA groups are arranged in at least a first subordinate column and a second subordinate column arranged to rightward of the first subordinate column in the visual representation of the layout, wherein a given one of the subordinate FMEA groups in the second subordinate column is semantically subordinate to a given one of the subordinate FMEA groups in the first subordinate column.

Clause 14. The method of Clause 13, wherein: the nodes comprise a single system element node of the system element node type in each of the one or more groups; a plurality of the superordinate FMEA groups are arranged in the first superordinate column in order of their creation times such that those with earlier creation times are arranged above those with later creation times in the visual representation of the layout; and a plurality of the subordinate FMEA groups are arranged in the first subordinate column in order of their creation times such that those with earlier creation times are arranged above those with later creation times in the visual representation of the layout.

Clause 15. The method of any one of Clauses 1-14, wherein: a given edge of the edges represents a relationship between a first node and a second node of the nodes; and the absolute position for the given edge is determined such that the given edge originates at the first node and terminates at the second node in the visual representation of the layout.

Clause 16. The method of Clause 15, wherein determining the geometry of the given edge comprises: determining absolute positions for one or more 90° angles in the given edge in the visual representation of the layout based on the absolute positions for the first node and the second node.

Clause 17. The method of any one of Clauses 1-16, wherein the graph traversal comprises at least one of the following: a breadth-first graph traversal; or a depth-first graph traversal.

Clause 18. A computing system comprising: at least one hardware processor; at least one memory coupled to the at least one hardware processor; and one or more non-transitory computer-readable media having stored therein computer-executable instructions that, when executed by the computing system, cause the computing system to perform: receiving semantic data regarding a Failure Mode and Effects Analysis (FMEA), wherein the semantic data specifies one or more groups of nodes, respective semantic group types of the one or more groups, respective semantic node types of the nodes, and relationships between the nodes; receiving a request to generate a visual representation of a layout for the FMEA; and in response to the request: pre-processing the semantic data to generate preliminary layout data for the FMEA, wherein the preliminary layout data specifies relative positions of the one or more groups, relative positions of the nodes within the groups, and positions of edges relative to the nodes; processing the preliminary layout data to generate processed layout data for the FMEA, wherein the processing comprises determining absolute positions for the nodes and the edges and geometries for the edges; rendering the visual representation of the layout for the FMEA based on the absolute positions for the nodes and the edges and the geometries for the edges; and outputting the visual representation of the layout.

Clause 19. The system of Clause 18, further comprising a user interface displaying the visual representation of the layout.

Clause 20. One or more non-transitory computer-readable media comprising computer-executable instructions that, when executed by a computing system, cause the computing system to perform operations comprising: receiving semantic data regarding a Failure Mode and Effects Analysis (FMEA), wherein the semantic data specifies one or more groups of nodes, descriptive text for the respective nodes, respective semantic group types of the one or more groups, respective semantic node types of the nodes, and relationships between the nodes, and wherein a given group of one or more the groups comprises a system element node that represents a system element of the FMEA, a function node that represents a function of the system element, and a failure mode nodes that represents a failure mode of the function; processing the semantic data to generate layout data for the FMEA, wherein the processing comprises determining absolute positions for nodes, determining absolute positions for edges representing the relationships between the nodes, and determining geometries for the edges; rendering a visual representation of a layout for the FMEA based on the layout data, wherein in the visual representation of the layout, the function node is centered below the system element node, the failure mode node is arranged below and rightward of the function node in a cherry-on-tree formation, and the respective nodes are labeled with the descriptive text; and outputting the visual representation of the layout for display via a user interface.

### Example—Example Advantages

A number of advantages can be achieved via the technologies described herein.

For example, the semantically-aware layouts described herein improve usability by respecting the semantic relationships and properties of FMEA elements (e.g., nodes, groups, and edges). Accordingly, the various elements of an FMEA are laid out in positions that conform to user expectations.

Further, in contrast to existing techniques, newly added nodes (functions, failure modes or newly-connected system elements) are also placed in expected positions. Accordingly, end users are less likely to get lost in large graphs (e.g., as FMEAs have the tendency to be large in real-world scenarios).

As another example, the layouts produced by the techniques described herein place FMEA elements at positions which minimize overlapping between edges, which further improves legibility for users viewing the layout.

For at least the above reasons, the semantically-aware layouts generated by the techniques are easy to read and understand for end users who are familiar with the FMEA methodology.

### Example—Example Computing Systems

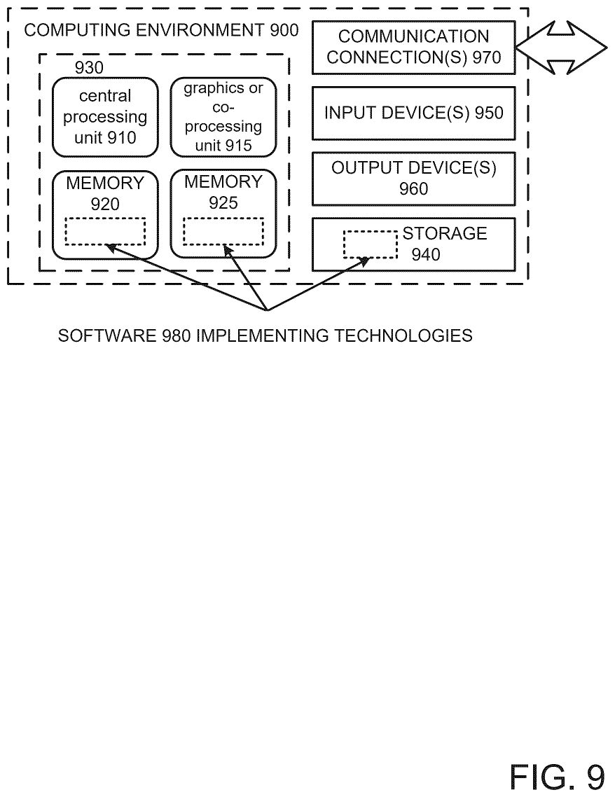

FIG. 9 depicts an example of a suitable computing system 900 in which the described innovations can be implemented. The computing system 900 is not intended to suggest any limitation as to scope of use or functionality of the present disclosure, as the innovations can be implemented in diverse computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 can be volatile memory (e.g., registers, cache, RAM), non-volatile memory (e.g., ROM, EEPROM, flash memory, etc.), or some combination of the two, accessible by the processing unit(s) 910, 915. The memory 920, 925 stores software 980 implementing one or more innovations described herein, in the form of computer-executable instructions suitable for execution by the processing unit(s) 910, 915.

A computing system 900 can have additional features. For example, the computing system 900 includes storage 940, one or more input devices 950, one or more output devices 960, and one or more communication connections 970, including input devices, output devices, and communication connections for interacting with a user. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 can be removable or non-removable, and includes magnetic disks, magnetic tapes or cassettes, CD-ROMs, DVDs, or any other medium which can be used to store information in a non-transitory way and which can be accessed within the computing system 900. The storage 940 stores instructions for the software 980 implementing one or more innovations described herein.

The input device(s) 950 can be an input device such as a keyboard, mouse, pen, or trackball, a voice input device, a scanning device, touch device (e.g., touchpad, display, or the like) or another device that provides input to the computing system 900. The output device(s) 960 can be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example—Example Cloud Computing Environment

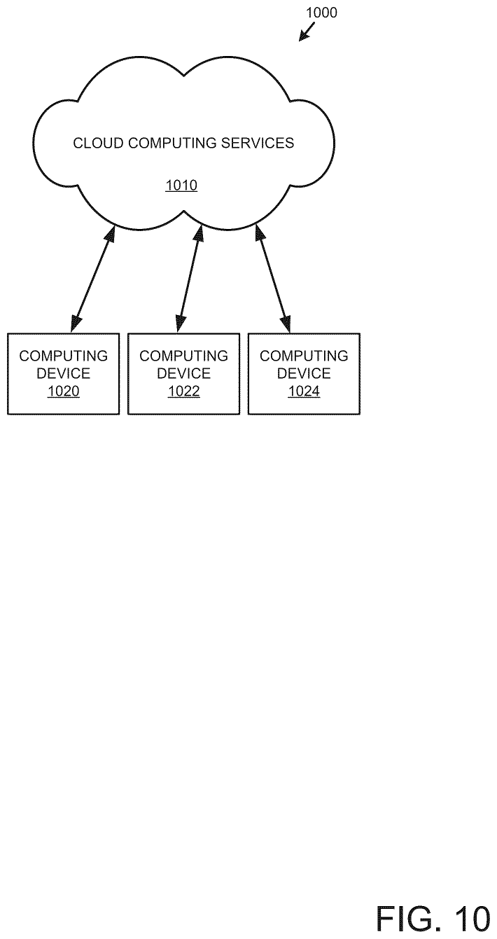

FIG. 10 depicts an example cloud computing environment 1000 in which the described technologies can be implemented, including, e.g., the system 100 of FIG. 1 and other systems herein. The cloud computing environment 1000 comprises cloud computing services 1010. The cloud computing services 1010 can comprise various types of cloud computing resources, such as computer servers, data storage repositories, networking resources, etc. The cloud computing services 1010 can be centrally located (e.g., provided by a data center of a business or organization) or distributed (e.g., provided by various computing resources located at different locations, such as different data centers and/or located in different cities or countries).

The cloud computing services 1010 are utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices. For example, the computing devices (e.g., 1020, 1022, and 1024) can utilize the cloud computing services 1010 to perform computing operations (e.g., data processing, data storage, and the like).

In practice, cloud-based, on-premises-based, or hybrid scenarios can be supported.

### Example—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving semantic data regarding a Failure Mode and Effects Analysis (FMEA), wherein the semantic data specifies one or more groups of nodes, respective semantic group types of the one or more groups, respective semantic node types of the nodes, and relationships between the nodes;
generating preliminary layout data for the FMEA, wherein generating the preliminary layout data for the FMEA comprises performing a graph traversal on the semantic data, and wherein the preliminary layout data specifies relative positions of the one or more groups, relative positions of the nodes within the groups, and positions of edges relative to the nodes;
generating processed layout data for the FMEA, wherein generating the processed layout data for the FMEA comprises:
determining absolute positions for the nodes based on the preliminary layout data and the respective semantic node types of the nodes; and
determining absolute positions and geometries for the edges based on the preliminary layout data and the absolute positions for the nodes;
rendering a visual representation of a layout for the FMEA based on the processed layout data; and
outputting the visual representation of the layout for display via a user interface.

2. The method of claim 1, wherein:
the semantic node type of a given one of the nodes is selected from the group consisting of:
a system element node type;
a function node type; and
a failure mode node type; and
the semantic group type of a given group of the one or more groups is selected from the group consisting of:
a focus FMEA group type;
a superordinate FMEA group type; and
a subordinate FMEA group type.

3. The method of claim 2, wherein:
the one or more groups comprise a single focus FMEA group of the focus FMEA group type; and
the absolute positions for the nodes are determined such that the focus FMEA group is arranged at a center of the visual representation of the layout.

4. The method of claim 3, wherein:
the one or more groups further comprise one or more superordinate FMEA groups of the superordinate FMEA group type; and
the absolute positions for the nodes are determined such that the one or more superordinate FMEA groups are arranged leftward of the focus FMEA group, and such that a topmost one of the one or more superordinate FMEA groups is offset downward relative to the focus FMEA group.

5. The method of claim 3, wherein:
the one or more groups further comprise one or more subordinate FMEA groups of the subordinate FMEA group type; and
the absolute positions for the nodes are determined such that the one or more subordinate FMEA groups are arranged rightward of the focus FMEA group, and such that a topmost one of the one or more superordinate FMEA groups is offset downward relative to the focus FMEA group.

6. The method of claim 2, wherein:
the given group comprises a single system element node of the system element node type and one or more function nodes of the function node type; and
the absolute positions for the system element node and the one or more function nodes are determined such that the system element node and the one or more function nodes are arranged in a column with the system element node centered above the one or more function nodes in the visual representation of the layout.

7. The method of claim 6, wherein:
the given group further comprises one or more failure mode nodes of the failure mode node type, wherein a given failure mode node of the one or more failure mode nodes represents a failure mode of a given function node of the one or more function nodes; and
the absolute position for the given failure mode node is determined such that the given failure mode node is arranged below and rightward of the given function node in the visual representation of the layout.

8. The method of claim 7, wherein:
a downward offset of the absolute position of the given failure mode node relative to the absolute position of the given function node is equal to or greater than a height of a symbol representing the failure mode node type in the visual representation of the layout; and
a rightward offset of the absolute position of the given failure mode node relative to the absolute position of the given function node is equal to or greater than a width of the symbol representing the failure mode node type in the visual representation of the layout.

9. The method of claim 7, wherein:
the given failure mode node is a first failure mode node of the given group;
the one or more nodes of the given group further comprise a second failure mode node of the failure mode node type, wherein the second failure mode node represents another failure mode of the given function node; and
the absolute position for the second failure mode node is determined such that the second failure mode node is arranged below and rightward of the first failure mode node.

10. The method of claim 9, wherein:
a downward offset of the absolute position of the second failure mode node relative to the absolute position of the given failure mode node is equal to or greater than a height of a symbol representing the failure mode node type in the visual representation of the layout; and
a rightward offset of the absolute position of the second failure mode node relative to the absolute position of the first failure mode node is equal to or greater than a width of the symbol representing the failure mode node type in the visual representation of the layout.

11. The method of claim 2, further comprising:
receiving data specifying respective creation times of the nodes,
wherein the determination of the absolute positions for the nodes is further based on the creation times of the nodes.

12. The method of claim 11, wherein:
the nodes of the given group comprise a plurality of function nodes of the function node type and a plurality of failure mode nodes of the failure mode node type;
the function nodes of the given group are arranged in order of their creation times such that those with earlier creation times are arranged above those with later creation times in the visual representation of the layout; and
the failure mode nodes of a given one of the function nodes of the given group are arranged in order of their creation times such that those with earlier creation times are arranged above those with later creation times in the visual representation of the layout.

13. The method of claim 2, wherein:
the one or more groups comprise a plurality of superordinate FMEA groups of the superordinate FMEA group type and a plurality of subordinate FMEA groups of the subordinate FMEA group type;
the superordinate FMEA groups are arranged in at least a first superordinate column and a second superordinate column arranged to leftward of the first superordinate column in the visual representation of the layout, wherein a given one of the superordinate FMEA groups in the second superordinate column is semantically superordinate to a given one of the superordinate FMEA groups in the first superordinate column; and
the subordinate FMEA groups are arranged in at least a first subordinate column and a second subordinate column arranged to rightward of the first subordinate column in the visual representation of the layout, wherein a given one of the subordinate FMEA groups in the second subordinate column is semantically subordinate to a given one of the subordinate FMEA groups in the first subordinate column.

14. The method of claim 13, wherein:
the nodes comprise a single system element node of the system element node type in each of the one or more groups;
a plurality of the superordinate FMEA groups are arranged in the first superordinate column in order of their creation times such that those with earlier creation times are arranged above those with later creation times in the visual representation of the layout; and
a plurality of the subordinate FMEA groups are arranged in the first subordinate column in order of their creation times such that those with earlier creation times are arranged above those with later creation times in the visual representation of the layout.

15. The method of claim 1, wherein:
a given edge of the edges represents a relationship between a first node and a second node of the nodes; and
the absolute position for the given edge is determined such that the given edge originates at the first node and terminates at the second node in the visual representation of the layout.

16. The method of claim 15, wherein determining the geometry of the given edge comprises:
determining absolute positions for one or more 90° angles in the given edge in the visual representation of the layout based on the absolute positions for the first node and the second node.

17. The method of claim 1, wherein the graph traversal comprises at least one of the following:
a breadth-first graph traversal; or
a depth-first graph traversal.

18. A computing system comprising:
at least one hardware processor;
at least one memory coupled to the at least one hardware processor; and
one or more non-transitory computer-readable media having stored therein computer-executable instructions that, when executed by the computing system, cause the computing system to perform:
receiving semantic data regarding a Failure Mode and Effects Analysis (FMEA), wherein the semantic data specifies one or more groups of nodes, respective semantic group types of the one or more groups, respective semantic node types of the nodes, and relationships between the nodes;
receiving a request to generate a visual representation of a layout for the FMEA; and
in response to the request:
pre-processing the semantic data to generate preliminary layout data for the FMEA, wherein the preliminary layout data specifies relative positions of the one or more groups, relative positions of the nodes within the groups, and positions of edges relative to the nodes;
processing the preliminary layout data to generate processed layout data for the FMEA, wherein the processing comprises determining absolute positions for the nodes and the edges and geometries for the edges;
rendering the visual representation of the layout for the FMEA based on the absolute positions for the nodes and the edges and the geometries for the edges; and
outputting the visual representation of the layout.

19. The system of claim 18, further comprising a user interface displaying the visual representation of the layout.

20. One or more non-transitory computer-readable media comprising computer-executable instructions that, when executed by a computing system, cause the computing system to perform operations comprising:
receiving semantic data regarding a Failure Mode and Effects Analysis (FMEA), wherein the semantic data specifies one or more groups of nodes, descriptive text for the respective nodes, respective semantic group types of the one or more groups, respective semantic node types of the nodes, and relationships between the nodes, and wherein a given group of one or more the groups comprises a system element node that represents a system element of the FMEA, a function node that represents a function of the system element, and a failure mode nodes that represents a failure mode of the function;
processing the semantic data to generate layout data for the FMEA, wherein the processing comprises determining absolute positions for nodes, determining absolute positions for edges representing the relationships between the nodes, and determining geometries for the edges;
rendering a visual representation of a layout for the FMEA based on the layout data, wherein in the visual representation of the layout, the function node is centered below the system element node, the failure mode node is arranged below and rightward of the function node in a cherry-on-tree formation, and the respective nodes are labeled with the descriptive text; and
outputting the visual representation of the layout for display via a user interface.
